(19) United States
(12) Patent Application Publication
(10) Pub. No.: US 2002/0026451 A1
(43) Pub. Date: Feb. 28, 2002

(54) System for providing medical moving picture and method thereof

(76) Inventor: Young Soo Lee, Kyoung-Ki-Do (KR)

Correspondence Address: GARDNER, CARTON & DOUGLAS, 321 N. CLARK STREET, SUITE 3400, CHICAGO, IL, 60610, US

(21) Appl. No.: 09/819,199

(22) Filed: Mar. 28, 2001

(30) Foreign Application Priority Data
Aug. 29, 2000 (KR) 2000-50512

(51) Int. Cl. G06F 17/30

(52) U.S. Cl. 707/104.1; 707/200

(57) ABSTRACT

The present invention provides a system for providing medical moving picture data of unborn child or baby affiliated with medical institute and studio on the internet. The system comprises the moving picture database for storing a moving picture data according to classified each baby of a user and multimedia server for receiving the moving picture data from information providing apparatus of the medical institute, storing the moving picture data with the moving picture database according to classified each baby and transmitting the moving picture data to a user service terminal on the request of the user.

According to the present invention, the moving picture and photos of baby may be easily accessible by the person related to the baby on the internet. The portal site related to baby may be easily established by system and method for providing medical moving picture of the present invent.

### BACKGROUND OF THE INVENTION

1) Field of the Invention

The present invention relates to system and method for providing medical moving picture on the internet, and more particularly, to system and method for providing medical information on babies working with affiliated medical institutes and affiliated studios on the internet.

2) Description of the Related Art

Currently, internet is prevailing in all fields of the world and the number of users is rapidly increasing. The internet provides many kinds of services in real world, for example, the expert site providing information about medical, legal, tax, etc., and gets into the spotlight. Especially, the expert site providing information about medical gives many types of services to people for free, but the website manager cannot provide high-quality contents because of lack of funds. Therefore, it cannot give a fully satisfaction to the users of the site.

Generally, people have to go to hospital or make a phone call to celebrate when babies are born, it gives people a burden of finance and time. Especially, inconvenience like this becomes worst case to the relatives living abroad.

### SUMMARY OF THE INVENTION

Therefore, the present invention has been made in an effort to solve the above-described problem.

It is an objective of the present invention to establish a community for family relatives and their next door neighbors to easily celebrate baby's birth without constraint of distance and time on the internet by receiving moving picture data and plural photos of an unborn fetus from affiliated medical institutes and studios, recording image data and photos providing server by a woman in childbed or other people and freely accessing image data and photos on the internet.

To achieve the above objective, the present invention provides a system for providing medical moving picture data of unborn child or baby with the help of affiliated medical institutes and studios on the internet. The system comprises the moving picture database for storing a moving picture data according to classified each baby of a user and multimedia server for receiving the moving picture data from information providing apparatus of the medical institute, storing the moving picture data with the moving picture database according to classified each baby and transmitting the moving picture data to a user service terminal on the request of the user.

Preferably, the system further comprising a photo database for storing a plural photos according to each baby of a user; and a photo server for receiving plural photos from studio, storing said plural photos in the photo database according to each baby and transmitting plural photos to a user service terminal on request of said user.

According to another aspect, the present invention provides a method of providing medical moving picture data in a system including relay apparatus for providing medical information about unborn child or baby with affiliated medical institute and studio on the internet, the method comprising storing a moving picture data according to a baby of each user after receiving said moving picture data from the medical institute and transmitting the moving picture data to a user service terminal on request of the user.

Preferably, the step of providing medical moving picture data comprising the step of storing plural photo data in database according to a baby of each user after receiving the photo data from affiliated studio; and the step of transmitting the plural photos to a user service terminal on request of the user.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a block diagram illustrating a system for providing medical moving picture according to the embodiment of the present invention.

FIG. 2 is a flowchart illustrating a process for providing moving picture data to a user after receiving moving picture data from a medical institute through the system for providing medical moving picture according to the present invention.

FIG. 3 is a flowchart illustrating a process for providing photo data on babies to a user after receiving photo data from a medical institute through the system for providing medical moving picture according to the present invention.

FIG. 4 is a flowchart illustrating a process from registration of member to providing moving picture information according to the present invention.

### DETAILED DESCRIPTION OF PREFERRED EMBODIMENTS

Reference will now be made in detail to the present preferred embodiments of the invention, an example of which is illustrated in the accompanying drawings.

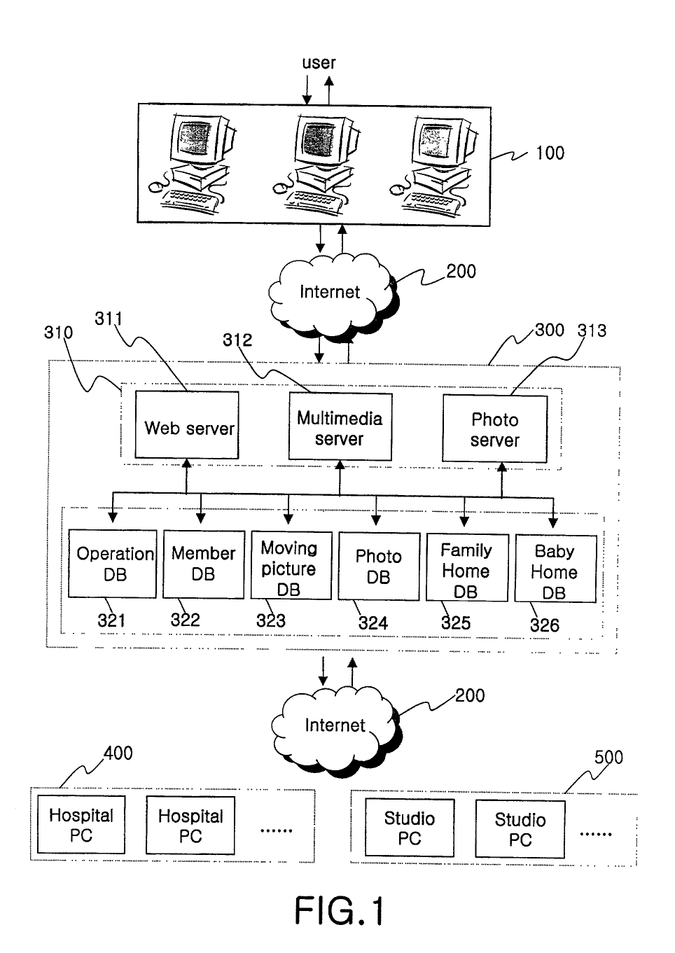

FIG. 1 shows a block diagram illustrating system for providing medical moving picture according to the present invention.

A system for providing medical moving picture according to the present invention consists of service device of the user 100, internet communication network 200, relay apparatus for providing medical moving picture 300, data providing apparatus of medical institutes 400 and data providing apparatus of studios 500.

The exemplary devices for service device of the user 100, data providing apparatus of medical institute 400 or data providing apparatus of studio 500 are commonly computers, PDA (Personal Digital Assistant) and other communication devices easily accessible to the internet 200.

Relay apparatus for providing medical moving picture 300 is a website for providing medical moving picture according to the present invention and consists of a processing part 310 and a database part 320. A processing part 310 consists of web server 311, multimedia server 312 and photo server 313. A database part 320 consists of operation DB 321, member DB 322, moving picture DB 323, photo DB 324, family home DB 325 and baby home DB 326.

Operation DB 321 stores a plurality of data necessary for relaying moving pictures or photo information according to the present invention, and operation DB 321 also stores medical information one at least one affiliated medical institute, at least one affiliated studio and at least one affiliated photo studios.

Member DB 322 stores member's basic information such as user's ID (identification), name and mailing address, password and the ID (identification) of baby, who is the main character of this system. Parents, relatives, family member and other user of the internet may be registered as a member.

Moving picture DB 323 stores moving picture data classified according to each baby of member. Moving pictures data may include monthly ultrasonic moving picture of an unborn baby, moving pictures showing a heart beat of a fetus, and moving pictures showing delivery and sound of baby's cry at the time of delivery, footprint and moving picture of a baby after delivery.

Photo DB 324 stores photo data classified according to each baby of member. Photo DB 324 may include monthly ultrasonic photos of a fetus, a photo showing the baby at the time of delivery, footprint and photos of a baby after delivery.

Family home DB 325 stores information on family home page and family may show their stories using family homepage. Family homepage may consist of a window for directly moving to baby homepage, family photos, calendar for informing of events of family, and a notice board for family news.

Baby home DB 326 stores information on baby home page classified according to each member's baby, by which family may inform their baby related information. Baby homepage may consist of at least one photo selected from photo DB 324 in which monthly ultrasonic pictures of an unborn child, picture showing a heart beat of the unborn child, and baby cry immediately after delivery, footprint and picture of the baby after delivery. Besides, baby home DB 326 may store monthly ultrasonic moving pictures of an unborn child, moving picture showing a heart beat of the unborn child, and baby cry immediately after delivery, footprint and moving picture of the baby after delivery. And it may be possible for special members to be authorized to get access to moving pictures on additionally prepared window.

Each database part 320 in relay apparatus 300 may be constructed in which data may be mutually connected with one another. And additional DB may be added to store additional data for close connection.

Web server 311 provides graphic and text information to be input or output on the screen of service utility terminal of the user 100 on the basis of data of operation DB 321. When a user registers for membership, user's basic information is registered in member DB 322, such as ID (identification), name and address, it password and ID of baby who is main character of this website according to the present invention. Parents, family, relatives, friends and other internet users may be registered as a member and more than one person may be serviced. When format of website for family home page and baby home page is input by a member, family home DB 325 and baby home DB 326 are updated according to input format data. Besides, web server 311 updates the contents provided from several affiliated medical institute and affiliated several studios. Service utility device of the user 100, data providing apparatus of medical institute 400 and data providing apparatus of studio 500 may be used as advertising server to advertise some commercial film and provide some useful information like a weather forecast.

Multimedia server 312 receives moving picture from data providing apparatus of affiliated medical institute 400, store it to moving picture DB 323 according to classified each baby, and transmit it to service utility device of the user 100 by responding to the request of a member. If the moving picture received from data providing apparatus of medical institute 400 is not compressed format, the amount of data to transmit is so much that it takes too long to transmit moving picture. Therefore, the moving picture is compressed and then stored and transmitted as compressed format in multimedia server 312.

Photo server 313 receives photos from data providing apparatus of affiliated medical institute 400, stores photos to photo DB 324 according to classified each baby, and transmits it to service utility device of the user 100 by responding to the request of a member.

The following figures illustrate functional operation of the embodiment of the present invention.

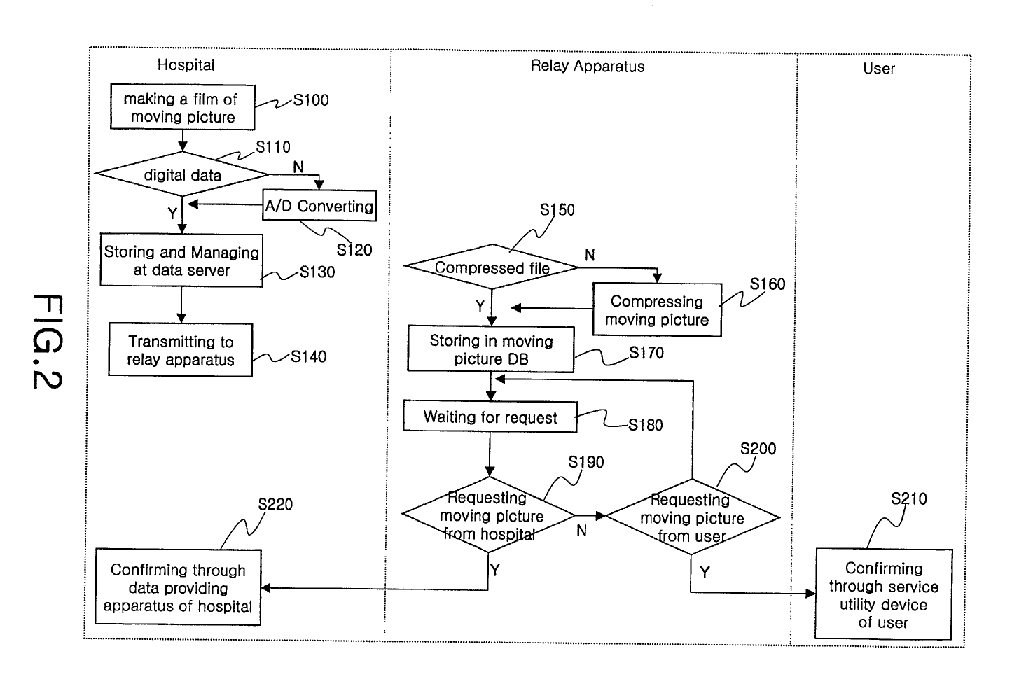

FIG. 2 is a flowchart illustrating a sequential process for providing moving picture data to a user after receiving moving picture data from a medical institute in the system for providing medical moving picture.

Hospital and other medical institute make a film of ultrasonic moving picture of an unborn child and other moving picture like moving picture showing a cry immediately after delivery, footprint and at least one moving picture of said baby after delivery (S100). When moving picture is analog signal (S110), the analog signal is converted to digital signal by A/D converter (S120). The converted digital signal is stored and managed in data server which is included in data providing apparatus of medical institute (S130). Then the hospital affiliated with relay apparatus for providing medical moving picture 300 transmits moving picture data to relay apparatus 300 (S140).

If transmitted moving picture from relay apparatus (300) is not compressed (S150), the amount of data to transmit is so much that it takes too long to transmit moving picture. Therefore, the moving picture is compressed (S160) and is stored as compressed format in moving picture DB (S170). Relay apparatus 300 waits the request of the user or hospital having transmitted moving picture (S180).

When hospital requests information to confirm the registration of moving picture after hospital has transmitted moving picture to relay apparatus 300 (S190), hospital may ascertain whether moving picture is registered or not by accessing the screen of data providing apparatus 400 of medical institute (S220).

When a member, who is a registrant of baby web site, requests moving picture of baby by baby home page (S200), the member may ascertain whether information of moving picture through service utility is registered or not (S210).

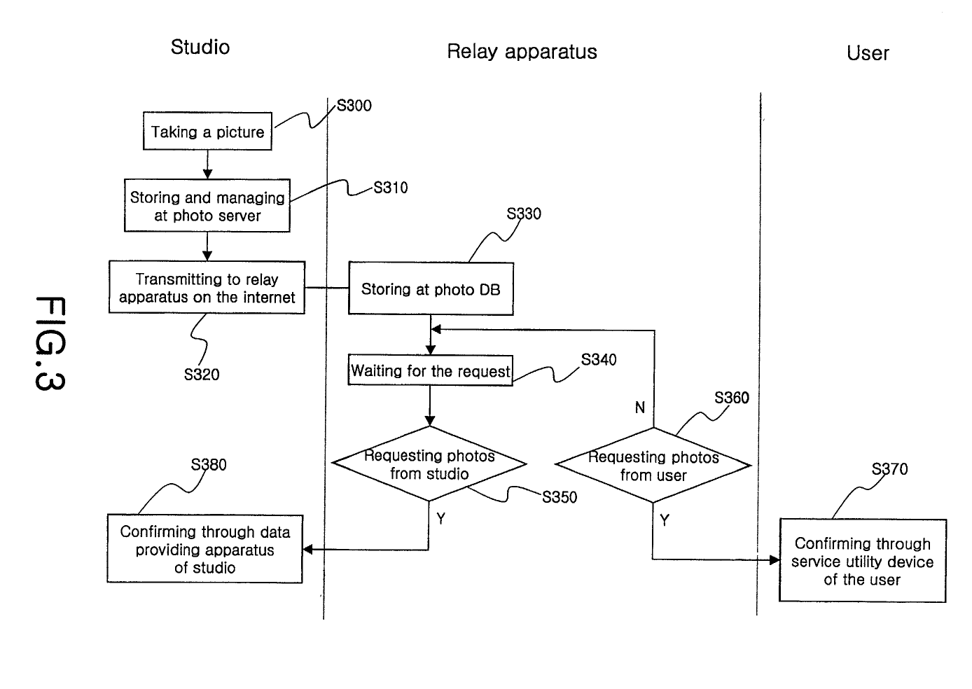

FIG. 3 is a flowchart illustrating a process for providing photo data to a user after receiving photo data from a medical institute in the system for providing medical moving picture.

Photo studio takes photographs like a monthly ultrasonic photo of an unborn child, a photo of the baby immediately after delivery, footprint, a photo of one hundredth day, a photo of a baby's first birthday and at least one photo of the baby after delivery (S300) using digital camera. The photos taken at photo studio are stored and managed in a photo server which is an components of the system of data providing apparatus 500 of studio (S310). The studio affiliated with relay apparatus 300 transmits above photos to relay apparatus (S320).

Photos transmitted to relay apparatus 300 are stored in photo DB 324 (S330). Relay apparatus 300 waits the request of the user or studio having transmitted photos (S340).

When studio requests information to confirm the registration of photos after hospital has transmitted photos to relay apparatus 300 (S350), studio may ascertain whether photos are registered or not through the screen of data providing apparatus 500 of studio (S380).

When a member, who is a registrant of baby web site, requests photos of baby through baby home page (S360), the member may view photos of baby through service utility (S370).

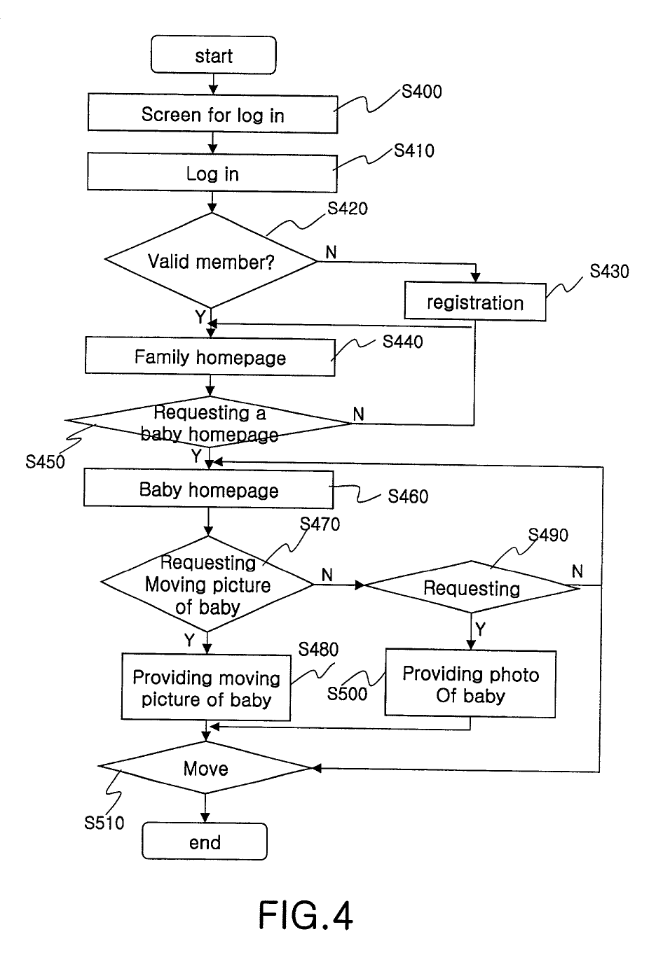

FIG. 4 is a flowchart illustrating a process from registration for membership to provision of moving picture information.

As shown in FIG. 4, when a user gets access to relay apparatus 300 to receive the service of medical moving picture, the login screen is displayed (S400). If the user is a member (S420) when he input user identification and password (S410), he may use the service of family homepage (3440). When a user is not a member, he may register for membership (S450). And then he may use the service of family homepage (S440). Parents, family, relatives, friends and other internet users including person himself may be registered as a member in order to receive service of the present invention. All kinds of subject about family may be accessed by members access to family homepage. Family homepage may include a window for directly moving to baby homepage, photos of family, a calendar for notifying of family schedule and a notice board for family.

When a member clicks a window for directly moving to baby homepage (S450), a baby homepage is provided. Baby homepage consists of at least one of photo selected from photo DB 324 having monthly ultrasonic photos, a photo of a baby immediately after delivery, footprint and at least one photo of a baby after delivery. A member may access and see the contents of photo DB 324 by the window related to other babies excepting babies are shown in banner. Also, baby homepage has additional window showing at least one moving picture selected from an ultrasonic moving picture of an unborn child, moving picture showing a heart beat of said unborn child, a moving picture showing a cry immediately after delivery, footprint and at least one moving picture of a baby after delivery. The above additional window for moving picture may be authorized to limited special members.

When a member clicks additional window (S470), multimedia server 312 of relay apparatus 312 extracts moving pictures of corresponding baby from moving picture DB 323 and transmits moving pictures to service utility device of the user 100 (S480). When a member clicks a window showing photos of baby (S490), the photo server 312 of relay apparatus 300 extracts corresponding photos from photo DB 324 and transmits photos to service utility device of the user 100 (3500).

As mentioned above, moving picture of affiliated medical institute and the photos of affiliated studio may be stored in moving picture DB 323 and photo DB 324 of relay apparatus on the internet, respectively. And a member may make family homepage and baby homepage using moving picture and photos of corresponding baby after logging in that homepage. Family and other people having some relationship with corresponding baby may look around family homepage and baby homepage without limitation of distance and time.

As above described, according to the present invention, the moving picture and photos of baby may be easily accessible by the person related to the baby on the internet. The portal site related to baby may be easily established by system and method for providing medical moving picture of the present invent.

As respect to members of the portal site, they may celebrate birth without a burden of finance and time. Finally, this portal site accomplished by the present invention will change a life-style. As respect to web site manager of the portal site, the registration fee may be gained by providing high quality contents about medical knowledge to the members.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. A system for providing medical moving picture data of a unborn child or a baby connected with an affiliated medical institute and an affiliated studio on an internet, said system comprising:
a moving picture database for storing said moving picture data classified according to each member's baby; and
a multimedia server for receiving said moving picture data from said medical institute, storing said moving picture data in said moving picture database, said moving picture data classified according to said each member's baby and transmitting said moving picture data to a member's service terminal on request of said member.

2. The system of claim 1, said system further comprising:
a photo database for storing photo data classified according to said each member's baby; and
a photo server for receiving said photo data from an information providing apparatus of said studio, storing said photo data in said photo database according to said each member's baby and transmitting said photo data to a member's service terminal on the request of said user.

3. The system of claim 1, wherein said moving picture data include a ultrasonic moving pictures of an unborn child, sound of heart beat of said unborn child, moving pictures of delivery of said baby, footprint and at least one moving picture of said baby after delivery.

4. The system of claim 2, wherein said photo data include an ultrasonic photo of an unborn child, a photo of said baby during delivery, footprint and at least one photo of said baby after delivery.

5. A method of providing medical moving picture data via a relay apparatus for providing medical information on a baby affiliated with a medical institute and a studio on an internet, said method comprising steps of:
(a) storing a moving picture data classified according to each member's baby after said relay apparatus receives said moving picture data from said medical institute; and
(b) transmitting said moving picture data to a member's service terminal on request of said member.

6. The method of claim 5, said method further comprising step of:
(c) storing photo data in said member's database classified according to each said member's baby after said relay apparatus receives said photo data from said affiliated studio; and
(d) transmitting photo data to said member's service terminal by said relay apparatus on request of said member.
